(19) United States
(12) Patent Application Publication
(10) Pub. No.: US 2023/0394439 A1
(43) Pub. Date: Dec. 7, 2023

(54) NO-CODE PROVISIONING OF WORKFLOW TASKS FOR MULTIPLE PROJECTS AND SERVICES IN CLOUD PLATFORMS

(71) Applicant: SAP SE, Walldorf (DE)

(72) Inventors: Yi Quan Zhou, Singapore (SG); Qiu Shi Wang, Singapore (SG)

(21) Appl. No.: 17/830,598

(22) Filed: Jun. 2, 2022

(51) Int. Cl. G06Q 10/10; G06Q 10/06

(52) U.S. Cl. CPC G06Q 10/103; G06Q 10/0633

(57) ABSTRACT

Methods, systems, and computer-readable storage media for receiving data as input to a workflow task user interface (UI) provided by a workflow task application, the data being representative of a task of a workflow, and determining that a decision action has been executed in response to user input to a UI element representative of the decision action, and in response, providing, from the workflow task application through an entry application within which the workflow task application executes, an update entity request, inserting, by the entry application, a set of properties to a header of the update entity request, and transmitting the update entity request to a data service to update a data object at least partially based on the data, a workflow service updating an instance of the workflow based on the set of properties.

### BACKGROUND

Users interact with computer-executed applications to perform a multitude of tasks. For example, in an enterprise setting, users can interact with one or more of an enterprise resource planning (ERP) application, a customer relationship management (CRM) application, and a human capital management (HCM) application to perform tasks in support of operations of an enterprise. To facilitate these interactions, applications are provisioned and include front-end components and back-end components. Example front-end components include user interfaces (UIs), which can include UI elements, through which users can interact with back-end components. Example back-end components include services (e.g., open data (OData) service, workflow service) that provide functionality. Users interact with the application by providing input to and receiving output from the UI elements. Example UI elements can include object pages, list pages, and analytics pages. Applications enable users to perform tasks as part of workflows.

### SUMMARY

Implementations of the present disclosure are directed to workflow task execution in workflow management systems. More particularly, implementations of the present disclosure are directed to enabling reuse of components of workflow management systems across multiple projects by decoupling components from workflow-specific properties.

In some implementations, actions include receiving data as input to a workflow task user interface (UI) provided by a workflow task application, the data being representative of a task of a workflow, and determining that a decision action has been executed in response to user input to a UI element representative of the decision action, and in response, providing, from the workflow task application through an entry application within which the workflow task application executes, an update entity request, inserting, by the entry application, a set of properties to a header of the update entity request, and transmitting the update entity request to a data service to update a data object at least partially based on the data, a workflow service updating an instance of the workflow based on the set of properties. Other implementations of this aspect include corresponding systems, apparatus, and computer programs, configured to perform the actions of the methods, encoded on computer storage devices.

These and other implementations can each optionally include one or more of the following features: the set of properties includes a task instance identifier that uniquely identifies a task of the instance of the workflow and a task decision identifier that uniquely identifies the decision action for the instance of the workflow; the data object is absent association with properties in the set of properties; actions further includes receiving a response to a data services request that is transmitted to the data service in response initiating execution of the workflow task, and determining whether a draft entity exists based on the response; actions further include, in response to determining that a draft entity exists, populating at least a portion of the workflow tasks UI with previously input data, wherein receiving data as input to a workflow task UI is executed in an editing mode; the data service transmits a task decision identifier of the set of properties to the workflow service, the task decision identifier uniquely identifying the decision action for the instance; and the workflow is defined within a computer-readable workflow model that that defines tasks and decision points of tasks, each decision element in a set of decision elements being associated with a decision point of the workflow model.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example architecture in accordance with implementations of the present disclosure.

FIGS. 3A-3F depict example code in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to workflow task execution in workflow management systems. More particularly, implementations of the present disclosure are directed to enabling reuse of components of workflow management systems across multiple projects by decoupling components from workflow-specific properties. In some examples, a workflow management system can include, but is not limited to, entry applications, workflow task applications, data entities that store data related to workflows, data modeling infrastructures, and services (e.g., data services, workflow services). In some implementations, and as described herein, components (e.g., data entities, workflow tasks) are decoupled through the absence of workflow-specific properties from components and addition of workflow-specific properties in requests to services.

In some implementations, actions include receiving data as input to a workflow task user interface (UI) provided by a workflow task application, the data being representative of a task of a workflow, and determining that a decision action has been executed in response to user input to a UI element representative of the decision action, and in response, providing, from the workflow task application through an entry application within which the workflow task application executes, an update entity request, inserting, by the entry application, a set of properties to a header of the update entity request, and transmitting the update entity request to a data service to update a data object at least partially based on the data, a workflow service updating an instance of the workflow based on the set of properties.

To provide further context for implementations of the present disclosure, and as introduced above, users interact with computer-executed applications to perform a multitude of tasks. For example, in an enterprise setting, users can interact with one or more of an enterprise resource planning (ERP) application, a customer relationship management (CRM) application, and a human capital management (HCM) application to perform tasks in support of operations of an enterprise. To facilitate these interactions, applications are provisioned and include front-end components and back-end components. Example front-end components include user interfaces (UIs), which can include UI elements, through which users can interact with back-end components. Example back-end components include services (e.g., open data (OData) service, workflow service) that provide functionality. Users interact with the application by providing input to and receiving output from UI elements. Example UI elements can include object pages, list pages, and analytics pages.

In some instances, applications enable users to perform tasks as part of workflows. In some examples, applications can partially automate tasks and integrate various services and systems into a cohesive application to execute operations of an enterprise. For example, a workflow can include a set of tasks that is to be performed by one or more users in furtherance of operations of an enterprise. In some examples, for each task, a UI is displayed to a user that enables the user to interact with a back-end services, such as a data service (e.g., OData service). In this sense, the UI can be referred to as a workflow task UI. In some examples, the user can input data to the UI and can make a decision associated with the task (e.g., by selecting a UI element). In response to the decision, the data is transmitted to the data service, which can commit the data to a database. Further, progression through the workflow can be recorded by a workflow service.

As digitalization of enterprise operations accelerate, an increasing number of applications and increased diversity in applications are required to be developed with less resources and time. However, there is a limited supply of professional developers that have the technical development skills and experience to develop such applications. Further, development lifecycles are time-consuming. Consequently, and among other issues, lack of technically proficient developers and length of development lifecycles present bottlenecks in provisioning applications. For enterprise operations, workflows can be considered a core technology of enterprise digitization. Like applications generally, state of art technology to provision workflow task applications requires the full stack of professional developers with profound technical knowledge of backend services, workflows, and front-end programming.

In view of the above context, implementations of the present disclosure are responsive to a demand for automatic creation of workflow tasks for non-technical users as so-called citizen developers in a no-code approach, the workflow tasks being reusable in multiple projects and services. In general, the term citizen developer refers to users who have little or no development experience yet seek to perform activities requiring some level of development experience, such as provisioning of workflow task functionality. Also, the term no-code generally refers to an absence of a need to develop code underlying an application or at least a portion thereof.

To this end, implementations of the present disclosure provide for automatic creation of metadata-driven workflow tasks in a no-code approach, each workflow task being usable in multiple projects and services. In some implementations, the workflow tasks are executable by users and can be accessed through an application. In some implementations, each workflow task is automatically integrated with one or more service tasks to establish outbound connectivity to external systems and services and interact with gateways and events to control a flow of the workflow. Implementations of the present disclosure can be provided as part of a no-code application studio to enable citizen developers to time- and resource-efficiently develop workflow tasks without coding.

For purposes of illustration, and without limitation, implementations of the present disclosure are described in further detail herein with reference to an example workflow. It is contemplated, however, that implementations of the present disclosure can be realized for any appropriate workflow. The example workflow includes a capital expenditure (capex) request workflow for an enterprise. In this example, the capex request workflow can include tasks of creating a capex request, filling in details of the capex request, attaching documentation in support of the capex request, if any, and submitting the capex request. These example tasks can be performed by a first user through one or more workflow task UIs. Continuing with this example, the capex request workflow can include tasks of reviewing the request, requesting additional information regarding the request, and approving/denying the request. These example tasks can be performed by a second user through one or more workflow task UIs.

In this example, a data service and a workflow service (both being back-end services) can be provided. In some examples, the data service updates data to a database system that is entered through the one or more workflow task UIs. For example, the database can maintain data objects (e.g., tables) that store data relevant to the capex request (e.g., name of first user, role of first user, date of request, amount of request, documentation supporting the request). In some examples, the data objects each have an associated data schema defining how data is stored therein. In some examples, the data service receives data that is submitted through the one or more workflow task UIs and stores the data in appropriate data object(s) based on the data schema(s). In some examples, the workflow service defines the workflow and tasks thereof and maintains progress through instances of a workflow. For example, the workflow service maintains a definition of the capex request workflow including each task underlying the capex request workflow. In some examples, the workflow and tasks thereof are defined in a workflow model that is maintained by the workflow service. An instance of a workflow refers to an execution of the workflow. For example, in a first instance, a first capex request can be submitted and processed, and in a second instant, a second capex request (different from the first capex request) can be submitted and processed.

Implementations of the present disclosure are described in further detail herein with non-limiting reference to an example application. The example application includes, without limitation, the Workflow MyInbox application provided by SAP SE of Walldorf, Germany. In general, Workflow MyInbox can be described as an entry point for execution of workflow task applications (e.g., ERP application, CRM application, HCM application). For example, Workflow MyInbox provides a landing page that includes UI elements representative of one or more workflow task applications that a user (logged into Workflow MyInbox) can access to perform one or more tasks. The user can select a UI element to navigate to a workflow task UI of a workflow task application that enables the user to execute a task. While the Workflow MyInbox application is discussed herein for purposes of non-limiting illustration, it is contemplated that implementations of the present disclosure can be realized using any appropriate application.

Implementations of the present disclosure are also described in further detail herein with non-limiting reference to an example data modeling infrastructure. As a non-limiting example of a data modeling infrastructure, Core Data Services (CDS), provided by SAP SE, was introduced to enable definition and consumption of data models on the database server (database-level) rather than on an application server (application-level). In general, CDS can be described as a data modeling infrastructure that simplifies and harmonizes the definition and consumption of data models, regardless of the consumption technology. Data modeling infrastructures, such as CDS, provide capabilities including, but not limited to, support for conceptual modeling and relationship definitions, built-in functions, and extensions. In some instances, a data modeling infrastructure can be implemented at the application-level, enabling developers to work in application-level development tools, while the execution of resulting code is pushed down to the database-level (hence, referred to as code-to-data or code pushdown).

In further detail, CDS can be described as an infrastructure that can be used by developers to create the underlying (persistent) data model which the application services expose to UI clients. For example, developers define the data-persistence and analytic models that are used to expose data in response to client requests (e.g., through HTTP requests). Developers can use CDS to define a persistence model within a database that includes objects such as tables, views, and structured types. In general, the database objects specify what data to make accessible for consumption by applications and how the data is to be consumed.

Implementations of the present disclosure are also described in further detail herein with reference to an example application platform that enables the development, deployment, and use of applications that enable users to execute workflow tasks in support of, for example, enterprise operations. An example application platform includes the SAP Mobile Development Kit (MDK) provided by SAP SE. Although MDK is discussed herein for purposes of illustrating implementations of the present disclosure, implementations of the present disclosure can be realized using any appropriate application platform.

In some examples, application platforms, such as MDK, include a design-time environment and an application that is developed using the application platform. An application can includes mobile services and a web runtime. In some examples, the design-time environment provides a web-based editor that enables users to create workflow tasks for applications. In the context of MDK, the editor of the design-time environment is provided as a SAP Business Application Studio space. In some examples, the mobile services (e.g., SAP Mobile Services) provide enterprise services that can include, but are not limited to, on-boarding, authentication, offline accessibility, and lifecycle management. In some examples, the web runtime (e.g., MDK Web Runtime) is a runtime for the applications. One or more users interact with an application through a mobile client, which is provided as a native application that executes on a client device.

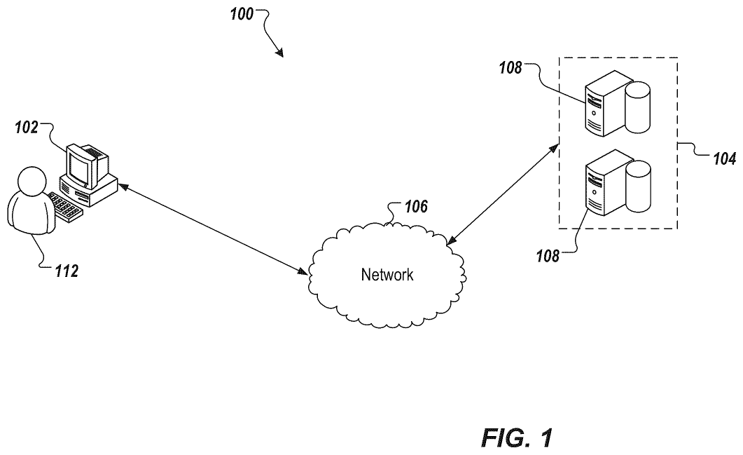

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106). In some examples, the server system 104 can provision a cloud platform that hosts one or more cloud-based applications.

In accordance with implementations of the present disclosure, the server system 104 can host an application (e.g., Workflow MyInbox), through which one or more workflow task applications can be accessed to enable users, such as the user 112, to execute workflow tasks. In some examples, the server system 104 hosts one or more back-end services and one or more database systems that facilitate execution of workflow tasks. For example, a data service can be hosted within the server system 104 that enables data provided through execution of workflow tasks to be stored and maintained (e.g., modified) within a database system. As another example, a workflow service can be hosted within the server system 104 that provides workflow models and maintains instances of execution of workflows.

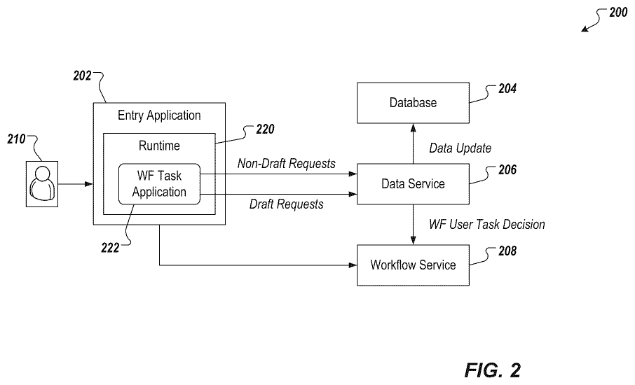

FIG. 2 depicts an example architecture 200 in accordance with implementations of the present disclosure. The example architecture 200 includes an entry application 202 (e.g., Workflow MyInbox), a database system 204, a data service 206 (e.g., OData service), and a workflow service 208. In the example of FIG. 2, a user 210 interacts with the entry application 202 through, for example, a client device (e.g., the client device 102 of FIG. 1). In the example of FIG. 2, the entry application 202 includes a runtime 220 (e.g., MDK runtime), within which a workflow task application 222 is executed. As described herein, the workflow task application enables the user 210 to execute one or more workflow tasks through one or more workflow task UIs.

As described in further detail herein, implementations of the present disclosure distinguish between draft data service requests and non-draft data service requests. In some examples, a data service request is a request that is transmitted to the data service 206 to store and/or modify data maintained within the database system 204. In some examples, a draft data service request refers to a workflow task that is partially complete, but data entered has not been committed to the database system 204. For example, this can occur in a circumstance, in which the user 210 inputs data and/or makes selections to a workflow task UI, but has not otherwise completed the underlying task (e.g., has not executed a task decision, such as submit, approve/deny). In such cases, the interactions of the user 210 are stored in draft form. In this sense, a draft can be considered as an interim version of a data entity that is automatically saved in an edit state. This provides improved user experience by allowing users to resume editing with unsaved changes from interrupt, preventing data loss (e.g., in case the workflow task application terminates unexpectedly). It also serves as locking mechanism to ensure users are aware of unsaved changes by another user and prevent data editing conflict and ensure data consistency. In some examples, a non-draft data service request refers to a workflow task that is freshly started by the user (e.g., no prior user interactions to the workflow task).

In some implementations, the workflow task application 222 integrates the operational flow of draft data service requests and non-draft data service requests seamlessly behind the scenes. In some examples, when the workflow task application 222 is loaded to the entry application 202, service data is retrieved from the data service 206 is retrieved to determine whether there is a draft service request. If there is a draft service request, a draft editing request is sent to the data service 206 to indicate that the workflow task application is working in a draft editing mode. If there is no draft service request, the service data is used as context for the workflow task application (e.g., if the task is to approve a capex request, the service data is data describing the capex request and/or documents supporting the capex request to reviewed and an approve/deny task to be executed).

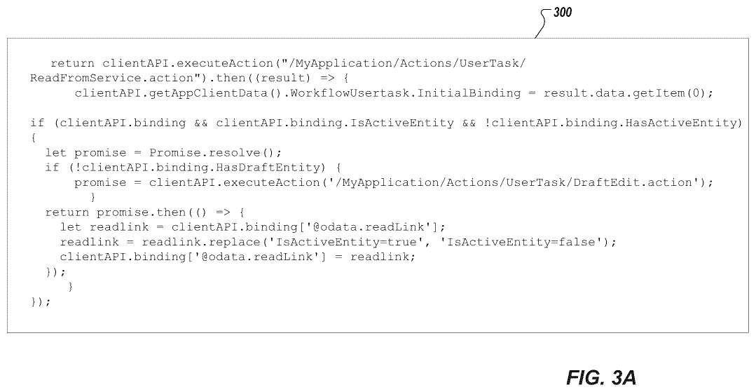

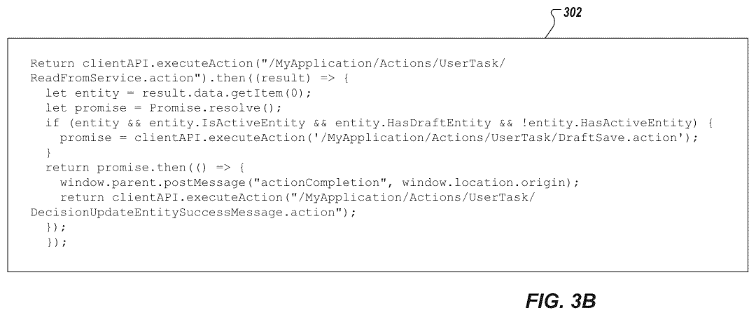

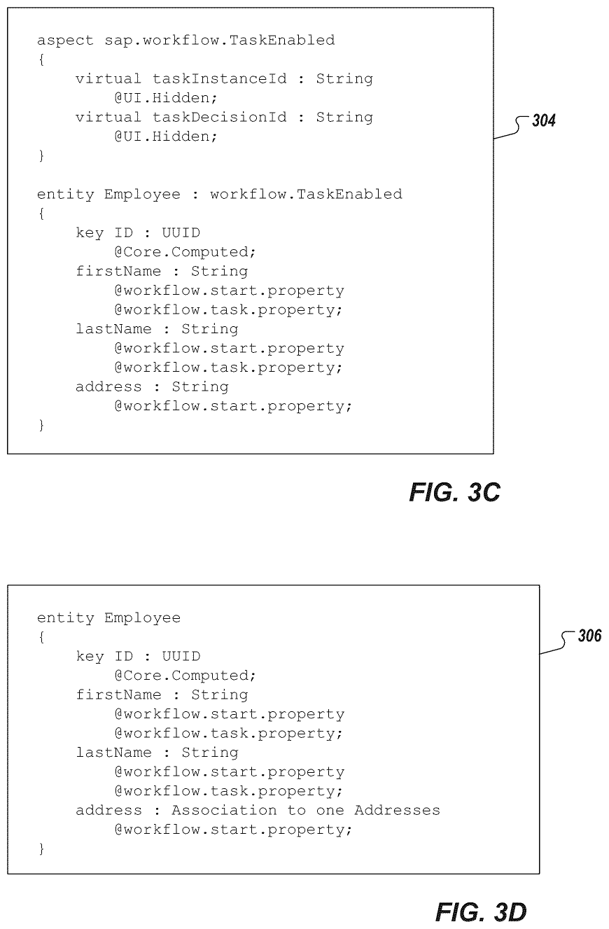

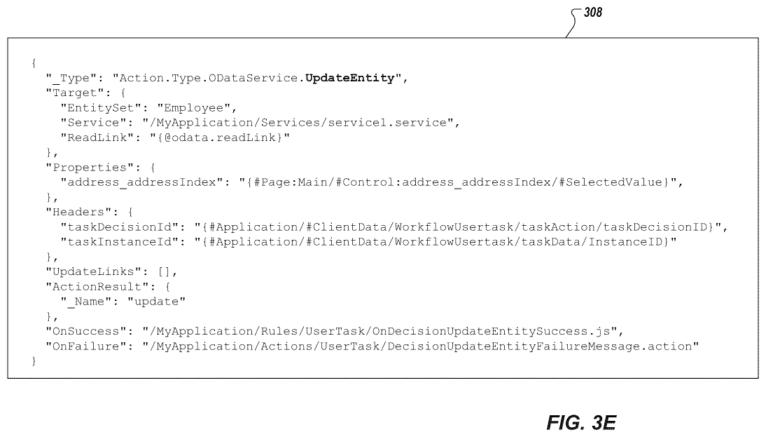

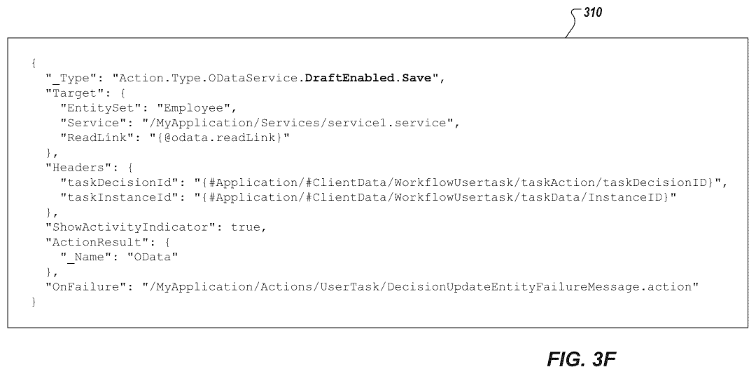

FIG. 3A depicts example code 300 in accordance with implementations of the present disclosure. In some implementations, the example code 300 executes a read from service action to read service data from a data service (e.g., the data service 206 of FIG. 2) to receive a result therefrom. In some examples, the result indicates whether a draft is present. If a draft is present, the existing service data is displayed in the workflow task UI, which functions in an editing mode to enable the user to edit existing data and/or execute other interactions (e.g., execute a decision on the task).

In some examples, in response to the user executing a decision of the task (e.g., selecting an approve UI element, selecting a deny UI element), a data query is sent to determine whether the service data was entered during the editing mode. If the data was entered during the editing mode, an OData update request is sent to update any change(s) to the service data by the user, and a draft preparing and a draft saving request are sent to complete the OData update through the draft service. If the data was not entered during the editing mode, the OData updating request ensures the update in the data service. This is represented in example code 302 of FIG. 3B. In short, data entered as part of the workflow task is committed to a data object (entity) within a database system (e.g., the database system 204 of FIG. 2).

In accordance with implementations of the present disclosure, the workflow task application enables reuse of workflow tasks by decoupling the workflow tasks from underlying data models (e.g., data models defined using CDS) and workflow services. More particularly, using CDS as an example and prior to implementations of the present disclosure, an data entity in CDS had to include some properties related to the workflow task. This is represented in the example code 304 of FIG. 3C, in which properties are required for taskInstanceID and taskDecisionID. That is, the example code 304 of FIG. 3C represents example code prior to implementations of the present disclosure. In the example of FIG. 3C, the entity Employee is associated with the properties taskInstanceID and taskDecisionID through an aspect sap.workflow.TaskEnabled. Here, the property taskInstanceID identifies a specific instance of a workflow (e.g., particular capex request workflow) and the property taskDecisionID identifies a specific decision result selected by a user in performance of a workflow task (e.g., approve decision, deny decision). In operation, and prior to implementations of the present disclosure, the workflow service (e.g., the workflow service 208 of FIG. 2) had to check these properties to identify and process the task accordingly. Further, and prior to implementations of the present disclosure, the workflow task application needs to pass the values of these properties from the instance of the workflow into requests to the workflow service. This was to ensure that the workflow service processes the request for the correct instance of the workflow.

Instead, and in accordance with implementations of the present disclosure, the workflow user application obtains the values of taskInstanceID and taskDecisionID from the entry application (e.g., Workflow MyInbox) and automatically configure these values into request headers to data services. For example, and in the example case of Workflow MyInbox, workflow tasks are provided in a master-detail column layout page, which includes a master column and a detail column. In the master column, a list of workflow tasks is provided and, in the detail column, details of a selected workflow task in master column are provided. In response to selection of a workflow task (task is considered active in response to selection), the runtime is loaded in the detail column with the task-related information obtained from Workflow MyInbox for the selected workflow task. In this manner, the runtime is able to identify and determine the taskInstanceId and taskDecisionId when there is an action triggered on UI for this workflow task.

In accordance with implementations of the present disclosure, the data structure (e.g., provided through CDS) does not need to include any properties related to the workflow service. This is represented in example code 306 of FIG. 3D. As depicted in FIG. 3D, the entity Employee is absent association with the properties taskInstanceID and taskDecisionID through the aspect sap.workflow.TaskEnabled, making the data entity generalized relative to workflow tasks. In this manner, the data entity can be used for any other projects that may or may not be associated with the particular workflow service.

Further, implementations of the present disclosure enable the data service to flexibly process data requests. For example, in response to receiving a data request, the data service need only determine whether there are dedicated properties in request headers, taskInstanceID and taskDecisionID, for the workflow. If yes, the data service processes the request for the workflow service indicated by the properties. If no, the data service processes the request as a normal data service without reference to the workflow service. Accordingly, the workflow task application can be incorporated and used for any other projects which incorporate workflow services.

In some implementations, the properties taskInstanceID and taskDecisionID are automatically processed into request headers of requests between the workflow service and the workflow task application using metadata. In FIGS. 3E and 3F, respective example code 308, 310 depicts this for non-draft service and draft service, respectively. In accordance with implementations of the present disclosure, the code is automatically generated without any coding required and is generalized across projects. Consequently, the data structure, workflow service, and workflow task application can be incorporated into other projects and reused. Further, during runtime (e.g., use of the workflow task application and workflow task UI(s) by a user to perform one or more tasks), the workflow task UI is rendered in the entry application to, for example, load the selected workflow task UI instance on the left-hand side and show the workflow task UI with data populated on right-hand side, as well as decision buttons (UI elements) in the footer of the entry application.

To further illustrate implementations of the present disclosure, a non-limiting example can be considered. In the non-limiting example, an example workflow can include an onboarding workflow to onboard a new employee into one or more enterprise systems. In this example, a workflow task UI can display data representative of the employee for a manager, for example, to review and approve. Depending on the type of service (draft enabled, non-draft enabled), multiple projects can be created. For example, a first project has a draft enabled service that handles creating an employee instance data object. For a second project, a non-draft enabled service handles updating some property of the employee instance data object in a workflow task. The data schema (e.g., CDS) of the employee data object can be created beforehand as a reusable artifact. In the first and second projects, the data schema can be directly imported without any adaption required. Further, the workflow task UI to create or edit an employee instance data, can also be created beforehand with configurable metadata, which can be used to display or hide particular UI elements. It can be imported to any projects and the metadata can be reconfigured to cater to different requirements.

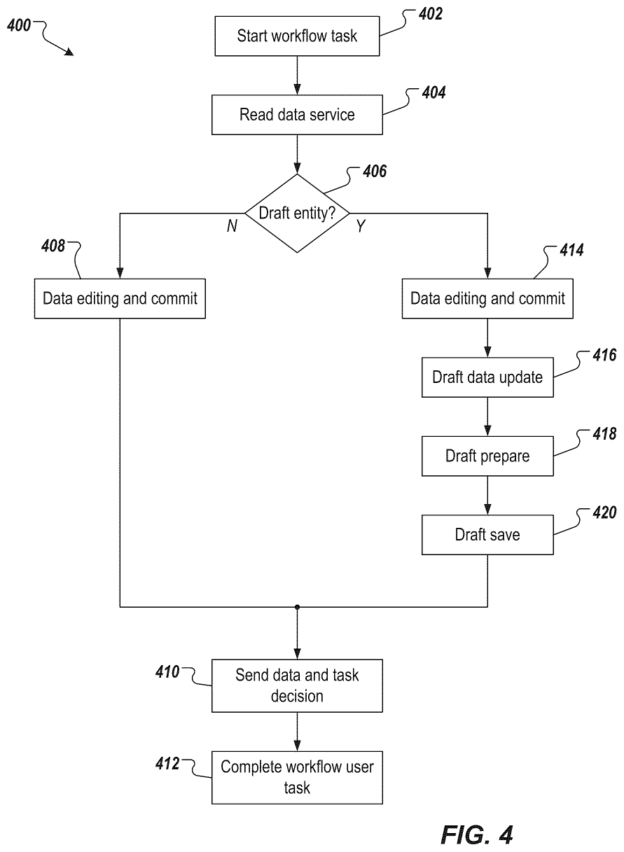

FIG. 4 depicts an example process 400 that can be executed in accordance with implementations of the present disclosure. In some examples, the example process 400 is provided using one or more computer-executable programs executed by one or more computing devices.

A workflow task is started (402). For example, a user 210 can open a workflow task UI of the workflow task application 222 within the entry application 220 (e.g., Workflow MyInbox). A data service is read (404). For example, in response to access to the workflow task UI, a service data read request is transmitted to the data service 206 to request any service data for a workflow task underlying the workflow task UI (e.g., example of FIG. 3A). The data service 206 provides a response. It is determined whether a draft entity exists (406). For example, the response indicates whether a draft entity exists for the workflow task.

If a draft entity does not exist, data editing and commit are performed (408), data and a task decision are sent (410), and the workflow task is completed (412). For example, the user 210 inputs data to the workflow task UI and executes a task decision (e.g., by selecting a UI element representative of the task decision). In response, the workflow task application 222 provides an update entity request through the entry application 202, which inserts a set of properties to a header of the update entity request. For example, the set of properties includes a taskInstanceID and a taskDecisionID for the workflow. The update entity request is transmitted to the data service 206 to update a data object in the database system 204. In some examples, the workflow service 208 updates an instance of the workflow based on the set of properties. For example, the data service 206 transmits the taskInstanceID and the taskDecisionID to the workflow service 208, which updates the instance of the workflow in response thereto.

If a draft entity does exist, data editing and commit are performed (414), draft data is updated (416), a draft is prepared (418), and the draft is saved (420). Data and a task decision are sent (410), and the workflow task is completed (412).

Implementations of the present disclosure provide multiple technical advantages. For example, implementations of the present disclosure provide a no-code, metadata driven approach that enables workflow task UIs to be developed and deployed in a time- and resource-efficient manner. As another example, implementations of the present disclosure provide a unified solution to support both draft and non-draft scenarios. For example, traditional approaches require that technically competent developers to write specific code to develop a workflow task application for the draft scenario and another for the non-draft scenario. In contrast, implementations of the present disclosure seamlessly incorporate the operation flow of draft and non-draft scenarios into the skeleton of the workflow task application. In this manner, a single workflow task application can be used for draft and non-draft scenarios without any coding effort to realized support of multiple back-end services in a no-code approach. As another example, implementations of the present disclosure provide for self-contained workflow tasks that can be used in multiple projects. For example, and as described herein, implementations of the present disclosure generate artifacts of the workflow task application to be absent dependency on workflow-specific attributes (e.g., as represented in FIG. 3D). Instead, implementations of the present disclosure use runtime request headers to identify properties indicating the particular workflow task with the back-end workflow service. In this manner, decoupling is provided across the board to enable reuse of data schemas, workflow services, and the workflow task application for multiple projects.

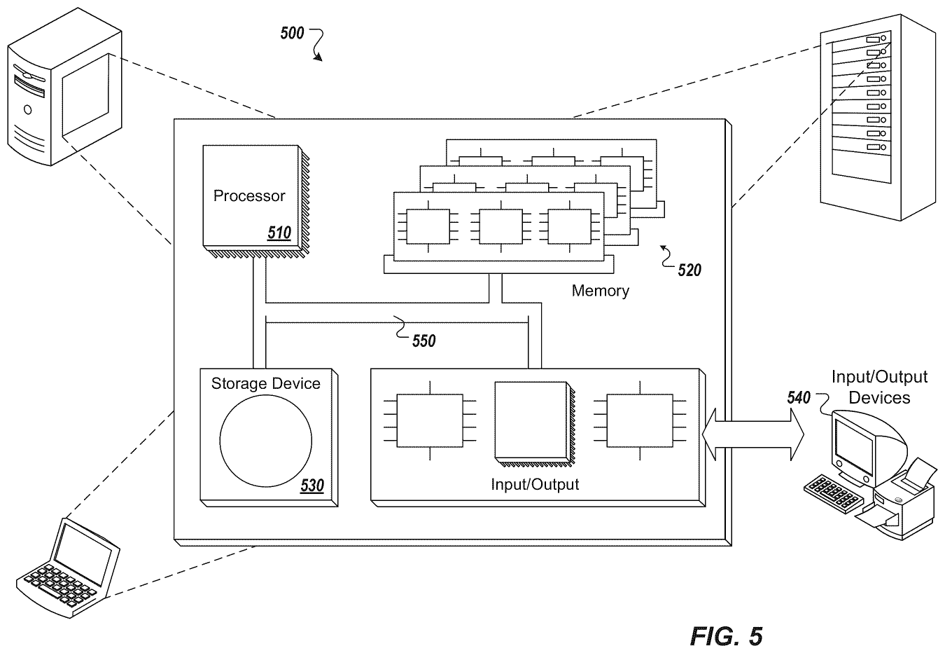

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for workflow task execution in workflow management systems, the method being executed by one or more processors and comprising:
receiving data as input to a workflow task user interface (UI) provided by a workflow task application, the data being representative of a task of a workflow; and
determining that a decision action has been executed in response to user input to a UI element representative of the decision action, and in response:
providing, from the workflow task application through an entry application within which the workflow task application executes, an update entity request,
inserting, by the entry application, a set of properties to a header of the update entity request, and
transmitting the update entity request to a data service to update a data object at least partially based on the data, a workflow service updating an instance of the workflow based on the set of properties.

2. The method of claim 1, wherein the set of properties comprises a task instance identifier that uniquely identifies a task of the instance of the workflow and a task decision identifier that uniquely identifies the decision action for the instance of the workflow.

3. The method of claim 1, wherein the data object is absent association with properties in the set of properties.

4. The method of claim 1, further comprising:
receiving a response to a data services request that is transmitted to the data service in response initiating execution of the workflow task; and
determining whether a draft entity exists based on the response.

5. The method of claim 4, further comprising, in response to determining that a draft entity exists, populating at least a portion of the workflow tasks UI with previously input data, wherein receiving data as input to a workflow task UI is executed in an editing mode.

6. The method of claim 1, wherein the data service transmits a task decision identifier of the set of properties to the workflow service, the task decision identifier uniquely identifying the decision action for the instance.

7. The method of claim 1, wherein the workflow is defined within a computer-readable workflow model that that defines tasks and decision points of tasks, each decision element in a set of decision elements being associated with a decision point of the workflow model.

8. A non-transitory computer-readable storage medium coupled to one or more processors and having instructions stored thereon which, when executed by the one or more processors, cause the one or more processors to perform operations for workflow task execution in workflow management systems, the operations comprising:
receiving data as input to a workflow task user interface (UI) provided by a workflow task application, the data being representative of a task of a workflow; and
determining that a decision action has been executed in response to user input to a UI element representative of the decision action, and in response:
providing, from the workflow task application through an entry application within which the workflow task application executes, an update entity request,
inserting, by the entry application, a set of properties to a header of the update entity request, and
transmitting the update entity request to a data service to update a data object at least partially based on the data, a workflow service updating an instance of the workflow based on the set of properties.

9. The non-transitory computer-readable storage medium of claim 8, wherein the set of properties comprises a task instance identifier that uniquely identifies a task of the instance of the workflow and a task decision identifier that uniquely identifies the decision action for the instance of the workflow.

10. The non-transitory computer-readable storage medium of claim 8, wherein the data object is absent association with properties in the set of properties.

11. The non-transitory computer-readable storage medium of claim 8, wherein operations further comprise:
receiving a response to a data services request that is transmitted to the data service in response initiating execution of the workflow task; and
determining whether a draft entity exists based on the response.

12. The non-transitory computer-readable storage medium of claim 11, wherein operations further comprise, in response to determining that a draft entity exists, populating at least a portion of the workflow tasks UI with previously input data, wherein receiving data as input to a workflow task UI is executed in an editing mode.

13. The non-transitory computer-readable storage medium of claim 8, wherein the data service transmits a task decision identifier of the set of properties to the workflow service, the task decision identifier uniquely identifying the decision action for the instance.

14. The non-transitory computer-readable storage medium of claim 8, wherein the workflow is defined within a computer-readable workflow model that that defines tasks and decision points of tasks, each decision element in a set of decision elements being associated with a decision point of the workflow model.

15. A system, comprising:
a computing device; and
a computer-readable storage device coupled to the computing device and having instructions stored thereon which, when executed by the computing device, cause the computing device to perform operations for natural language explanations for workflow task execution in workflow management systems, the operations comprising:
receiving data as input to a workflow task user interface (UI) provided by a workflow task application, the data being representative of a task of a workflow; and
determining that a decision action has been executed in response to user input to a UI element representative of the decision action, and in response:
providing, from the workflow task application through an entry application within which the workflow task application executes, an update entity request,
inserting, by the entry application, a set of properties to a header of the update entity request, and
transmitting the update entity request to a data service to update a data object at least partially based on the data, a workflow service updating an instance of the workflow based on the set of properties.

16. The system of claim 15, wherein the set of properties comprises a task instance identifier that uniquely identifies a task of the instance of the workflow and a task decision identifier that uniquely identifies the decision action for the instance of the workflow.

17. The system of claim 15, wherein the data object is absent association with properties in the set of properties.

18. The system of claim 15, wherein operations further comprise:
receiving a response to a data services request that is transmitted to the data service in response initiating execution of the workflow task; and
determining whether a draft entity exists based on the response.

19. The system of claim 18, wherein operations further comprise, in response to determining that a draft entity exists, populating at least a portion of the workflow tasks UI with previously input data, wherein receiving data as input to a workflow task UI is executed in an editing mode.

20. The system of claim 15, wherein the data service transmits a task decision identifier of the set of properties to the workflow service, the task decision identifier uniquely identifying the decision action for the instance.
